(19) United States
(12) Patent Application Publication
(10) Pub. No.: US 2015/0339947 A1
(43) Pub. Date: Nov. 26, 2015

(54) BEHAVIOR MODIFICATION SYSTEM, METHOD AND PROGRAM PRODUCT

(71) Applicant: Glen Knafel, Lebanon, CT (US)

(72) Inventor: Glen Knafel, Lebanon, CT (US)

(21) Appl. No.: 14/791,871

(22) Filed: Jul. 6, 2015

Related U.S. Application Data
(63) Continuation of application No. 13/155,772, filed on Jun. 8, 2011.

(51) Int. Cl. G09B 19/00

(52) U.S. Cl. CPC G09B 19/00

(57) ABSTRACT

A method, program product and interactive behavior modification system is provided that can be implemented as a board game or as part of a computing environment having at least a processor and a memory. The method comprises steps beginning with conducting an initialization step, via the processor, during which at least one participant, a threshold number of instances of behavior to trigger an outcome, and a plurality of categories of behavior are identified, and a plurality of outcomes is associated with each category of behavior. The method includes the further step of evaluating, via the processor, whether the number of instances of behavior by a participant in a category of behavior has exceeded the threshold number of instances of behavior and employing, via the processor, a random selector of outcomes to select an outcome to be imparted on the participant from the plurality of outcomes associated with the category of behavior for which the threshold number of instances of behavior has been exceeded.

### CROSS-REFERENCE TO RELATED APPLICATION

This application is a continuation of U.S. patent application Ser. No. 13/155,772, filed on Jun. 8, 2011, entitled “BEHAVIOR MODIFICATION SYSTEM, METHOD AND PROGRAM PRODUCT”, by Glenn Knafel, the entirety of which is incorporated by reference.

### FIELD OF INVENTION

This invention is generally directed to a behavior modification system and method and more particularly to a system and method that associates consequences with a variety of user actions based on one or more behavioral categories.

### BACKGROUND OF THE INVENTION

There are many circumstances where it may be desired to effectuate a change in behavior both in adults and children. Engaging in certain behavior may be either voluntary or involuntary. In addition, there may be a need to either actively discontinue the behavior or alternatively establish a habit where the behavior is almost automatically embraced. For example, in a medical environment, it may be desired to establish a habit or automate behavior in a patient to take a particular medication regularly. Alternatively, a child who involuntarily chews his or her nails may need to be reminded to discontinue the habit every time the activity takes place. Not all actions are involuntary and there are many instances where actions are voluntarily taken with or without the person's knowledge of their desirability or non desirability. For example, a child may not be aware that leaving toys on a stair case is a non-desired behavior. Similarly, an adult who is trying to quit smoking may still voluntarily engage in smoking a cigarette but later regret it.

In all circumstances, the effectiveness of a modification tool depends on its success in capturing the attention and interest of the individual in question. Methods of reward or punishment can be used alone or in conjunction with one another as further means to enforce desired behavior change. In addition, a consistent and objective manner of reinforcement can effectuate change when there is a reward or punishment method that is provided in an equitable manner.

Unfortunately, the prior art does not provide an effective manner that can both engage the interest and attention of the participant while providing reinforcements equitably. In addition, if there is an improvement or a relapse of the behavior, the current prior art cannot effectively register that change and incorporate it in the modification process to address participant needs on a dynamic basis.

Consequently, a new and improved technique is desirous that can effectuate behavior modification in an engaging manner that is objective and consistent in its treatment of participants. It would also be advantageous if such a technique can take into account the participants' change of behavior over time and adjust the reinforcements accordingly.

### SUMMARY OF THE INVENTION

The shortcomings of the prior art are overcome and additional advantages are provided through the provision of a method and apparatus.

The present invention provides for a system and method relating to interactive behavior modification techniques. In a first embodiment a housing is provided having a first area and a second area. A plurality of tickets are disposed on the housing contextually arranged by categories of behavior. Tickets are further contextually arranged by participant. A selector of predetermined outcomes is provided, capable of selecting a random outcome from a set of outcomes associated with a particular category of behavior.

In alternate embodiments, a computer program product and method for providing an interactive behavior modification system is also provided in a computing environment having at least a processor and a memory. The method comprises steps beginning with conducting an initialization step, via the processor. During the initialization step at least one participant, a threshold number of instances of behavior to trigger an outcome, and a plurality of categories of behavior are identified, and a plurality of outcomes is associated with each category of behavior. The embodiments include the further step of evaluating, via the processor, whether the number of instances of behavior by a participant in a category of behavior has exceeded the threshold number of instances of behavior, and employing, via the processor, a random selector of outcomes to select an outcome to be imparted on the participant from the plurality of outcomes associated with the category of behavior for which the threshold number of instances of behavior has been exceeded.

### BRIEF DESCRIPTION OF THE DRAWINGS

The subject matter which is regarded as the invention is particularly pointed out and distinctly claimed in the concluding portion of the specification. The invention, however, both as to organization and method of practice, together with further objects and advantages thereof, may best be understood by reference to the following description taken in connection with the accompanying drawings in which:

FIG. 1 is a perspective view illustrating a behavior modification system as per one embodiment of the present invention;

FIG. 2 is a block diagram illustrating an alternative embodiment of the present invention provided in conjunction with a computing environment and having a processor enabled to execute a digital version of the behavior modification system; and

FIG. 3 is a block diagram illustrating yet another alternative embodiment of the present invention having a facilitated network system with a plurality of nodes that are in processing communication with one another.

### DETAILED DESCRIPTION OF THE INVENTION

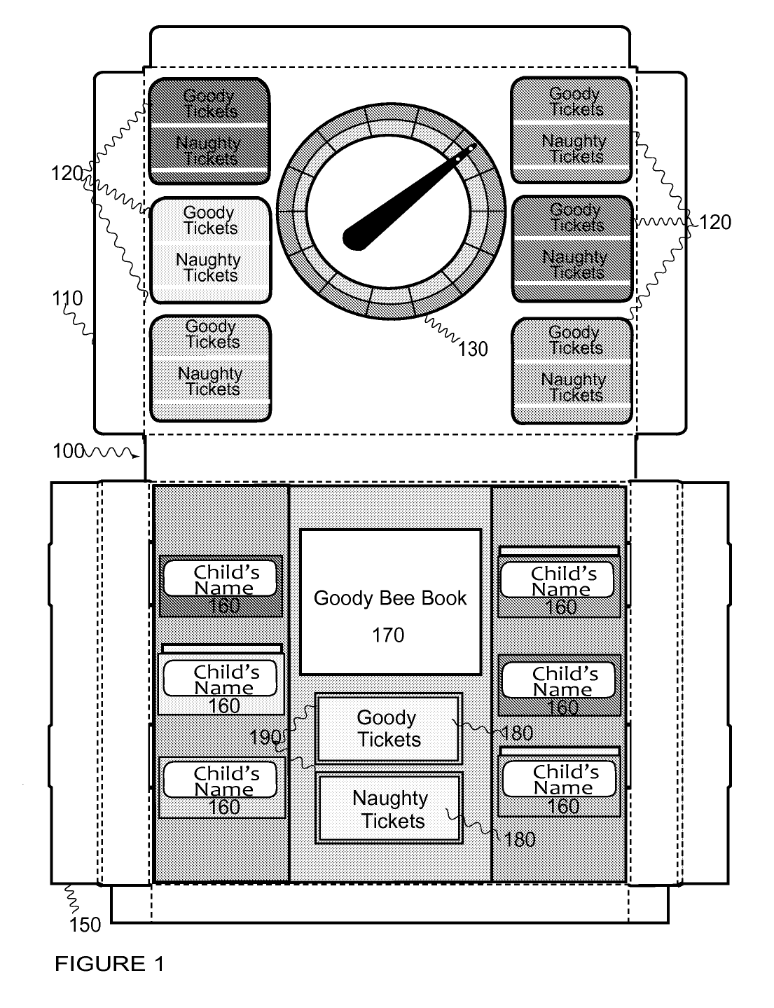

FIG. 1 is a perspective view of one embodiment of the present invention. In FIG. 1, an interactive behavior modification system is shown having a portable housing 100 with a first area 150 and second area 110. In this embodiment the behavior modification system is in the form of a board game but as known to those skilled in the art, alternate embodiments are possible.

As depicted in FIG. 1, a plurality of tickets 180 are stored contextually in a plurality of storage sites 120, 160, 190. The sites are disposed on a first area 150 and second area 110 of the portable housing 100. The term ticket(s) is used for ease of understanding and tickets are items comprised of a medium on which acts of participant behavior can be recorded. Consequently, the medium, as can be appreciated by those skilled in the art, can comprise a plurality of alternative means. In the figure shown, as an example and to aid understanding, a medium of card stock is presented.

Positional context can be used to indicate whether a ticket is associated with a particular participant or with no participant. Tickets not yet associated with a participant can be blank. Blank tickets are disposed in a plurality of primary storage sites 190 disposed on the first area 150 depicted in FIG. 1. Such blank tickets may nonetheless be inscribed with, and arranged by, categories of behavior. The primary storage sites may be comprised of depressions in the first area 150 or have other design complementary with the configuration and shape of the stacks of tickets to enable a secure holding area.

A specific behavioral act by a participant warranting the issuance of a ticket can be recorded on a blank ticket. That ticket can be associated with the participant by disposing it contextually by participant and category of behavior in the plurality of secondary storage sites 120. The secondary storage sites are in turn disposed on the second housing area 110. The secondary storage sites are comprised of a holding area, such as a pocket or perforated slit or the like as can be appreciated by those skilled in the art, for each participant in each category of behavior. The secondary storage sites may be disposed contextually in such a way that visual inspection quickly reveals the tickets associated with any participant in any category of behavior. Furthermore, a securing component (not illustrated) like means for hanging, such as a hook, or other similar arrangements as can appreciated by those skilled in the art may also be provided such as by attachment to the second housing area so that the secondary storage sites may be displayed by hanging.

In one embodiment, a plurality of per-participant containers 160, such as envelopes or card boxes, is preferably disposed in the first housing area. Tickets with recorded behavior may be disposed in these containers for archival such that they may be referenced as a persistent record of the historical behavior of participants. Such containers may include dividers or separators to separate tickets into categories of behavior.

A plurality of behavior categories can be selectively elected such as by a user, designer, computer or a participant prior to the start of the game or alternatively during game participation. In the example shown in FIG. 1, to aid understanding, this number is selected to equal two with the understanding that this number can be altered in different embodiments as known to those skilled in the art.

In the embodiment shown in FIG. 1, the two categories of behavior are established as namely that of desired and undesired behavior. This is to aid understanding and more or different categories can be introduced in alternate embodiments.

In this embodiment, there is a possibility for a threshold number of instances of behavior to trigger a consequence. In this particular example, two instances trigger a consequence. In one embodiment, a plurality of sets of outcomes can also be selectively devised such that they are suitable to the participant or participants, each set of outcomes to be associated with one of the categories of behavior. The content of each set of outcomes associated with each of the categories of behavior may be selectively determined during an initialization period or dynamically at some later point. For example, the set of outcomes associated with a desired behavior can include a desired or favored object, monetary compensation or even removal of a pre-existing restriction. Similarly, the set of outcomes associated with undesired behavior can include among other things, undesired results including but not limited to physical restraint to a place (time-out), removal of a desired object or even temporary or permanent loss of property or money. The elements of one set may or may not be contrary to elements of another set or category, selectively.

Referring back to FIG. 1, a random selector of predetermined outcomes, in this particular embodiment a spinner 130, is disposed on the second housing area 110. Alternative selectors are known to those skilled in the art. In this particular embodiment, the spinner is surrounded by a plurality of concentric rings, each ring being associated with one of the categories of behavior. The concentric rings are divided into sections such that each section of each ring is associated with a specific outcome in the set of outcomes associated with the category of behavior associated with the ring. An outcome associated with a specific category of behavior can thereby be determined by spinning the spinner, the outcome being determined by the section where the spinner stops in the ring associated with the category of behavior. In the event that the number of outcomes in each set of outcomes is the same, only one ring is necessary for all categories, the sections of that ring corresponding to one outcome in each category of behavior with the outcome thereby selected by the combination of section and category.

In one embodiment of the behavior modification system as provided in FIG. 1, once a participant exhibits behavior falling into one of the categories of behavior, the behavior is then recorded. The record, in the example provided in this embodiment can be reflected on a ticket and is associated with the participant and in this case a particular category of behavior. The record of behavior remains associated with the participant and category of behavior until a threshold number of such records is reached. When the threshold number of records for the participant in the category is reached, a random selector of outcomes is used to select an outcome from the set of outcomes associated with that category of behavior and that outcome is imparted on the participant. The records of behavior for the participant in the category of behavior are subsequently archived or discarded, such that for the purpose of imparting outcomes in the next iteration, there will be no existing records associated with that participant for that category of behavior. Thereafter the described process may iterate for any number of iterations, beginning with the recording of participant behavior. In this way an archival history of particular behaviors at a predetermined time and any improvements or regressions over time can be established and later analyzed, if desired. This analysis can be made per participant or according to behavior for a plurality of participants.

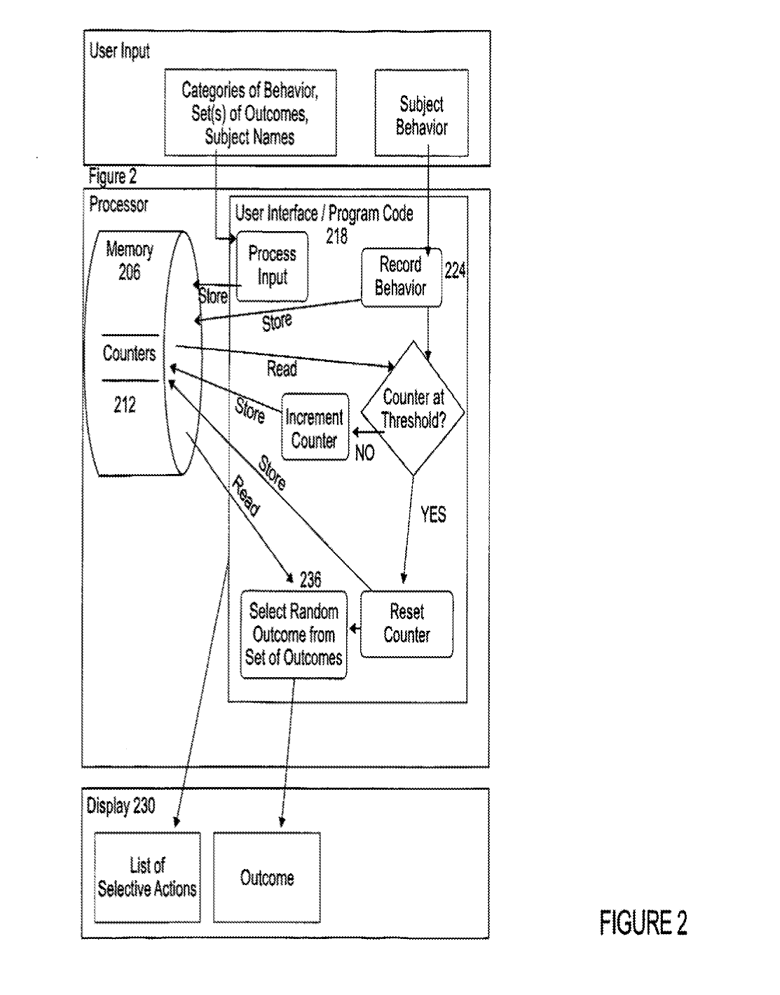

FIG. 2 is a block diagram of an alternate embodiment of the present invention showing a computing environment having a processor enabled to execute a digital version of the behavior modification system as discussed with reference to FIG. 1. An embodiment may be implemented entirely on a single device as depicted in FIG. 2, or alternatively with functions spread across a plurality of computing devices, such as a server device and a client device or a web server device and a client web browser device, as can be appreciated by those skilled in the art. In one embodiment, upon initialization, the processor may search a first memory location 206 for a saved profile. If one such profile exists, the processor may load it automatically. If more than one profile exists, the user may be prompted to choose one. If no profile exists, one may be created automatically. The user may also elect to create a new profile. The profile in one embodiment can be comprised of data stored, such as in files, during a prior execution or executions or may include preselected categories and other rules or restrictions associated with a particular game or participant. The processor also loads a user interface 218 that allows the user to provide input and control the execution of the program. The output can be depicted on a display 230 or an alternative means as can be appreciated by those skilled in the art.

In one embodiment, a user may be required to authenticate at initialization or prior to accessing a protected aspect of the embodiment. Authentication may be performed by entering a password, a username and password combination, by using biometric identification or by using other authentication credentials or methods as known to those skilled in the art. Authentication inhibits unauthorized users from accessing the embodiment or protected aspects of the embodiment. In addition, authentication identifies the user. A different profile or user interface may be selectively elected for different users. Different users may be presented with different participants, categories of behavior or outcomes, selectively. Different users may have different access levels. In one example to aid understanding, the authentication credentials of a parent or therapist may be required in order to add new participants or display the past behavior of any and all participants, whereas the credentials of a child participant user may only allow the user to view that participant's own past behavior. In a second example, a plurality of parents may each authenticate so that the participants displayed for each parent are their own children and the categories of behavior and outcomes are those selected by the individual parents irrespective of the selections made by others.

In a digital embodiment, the user interface is comprised of a plurality of options allowing the user to input information about each of the participants and categories of behavior. When the user inputs information, the processor stores it in memory 206 and in the profile on a storage device. The user interface allows the user to designate a plurality of outcomes in each set of outcomes, each set of outcomes being associated with a category of behavior. The user interface allows the user to add new participants and to input instances of behavior observed for each participant in each category of behavior. If no participants or categories have been defined, the user interface may automatically prompt the user to define them. Referring back to FIG. 2, when a user inputs an instance of behavior, the processor stores a record of the instance of behavior 224, including the participant who exhibited the behavior, the category the behavior falls into, and a description of the behavior. The record can be stored in a memory 206 as well as permanently in a profile.

Referring again to FIG. 2, in the embodiment, the processor maintains counters 212 of the number of active records, one associated with each participant in each category of behavior, which counter is incremented when a record is created for the associated participant in the associated category of behavior. A record is active immediately after it is entered and remains active until the counter for the associated category and participant reaches an assigned threshold number. When the counter reaches the assigned threshold number as pre-stored or selected initially, the processor randomly selects an outcome 236 from a file including one or more sets of pre-recorded outcomes associated with the particular category of behavior. The display may depict a pictorial representation of a selector of predetermined outcomes, such as the spinner 130 described in the embodiment illustrated in FIG. 1, as the outcome is being selected. The display 230 may then present the selected outcome so that it can be imparted on the participant. After the assigned threshold number has been reached, the counter for that participant for that category of behavior is reset to zero and the records previously active for that participant for that category of behavior can be archived on a storage device. The user interface in one embodiment allows a history of participant behavior to be created using the archived records. These can be printed or stored for each participant as desired or appropriate.

Again, as it was the case in a previous embodiment, archival records can then be further analyzed by a person or a processor to establish relational behavior changes per participant and behavior over time or during specific time periods. As can be appreciated by those skilled in the art, other relational data can also be added that can also be relevant to a final analysis. An example of the latter can be, for example, the occurrence of an event in the participant's life that may have impacted the behavior.

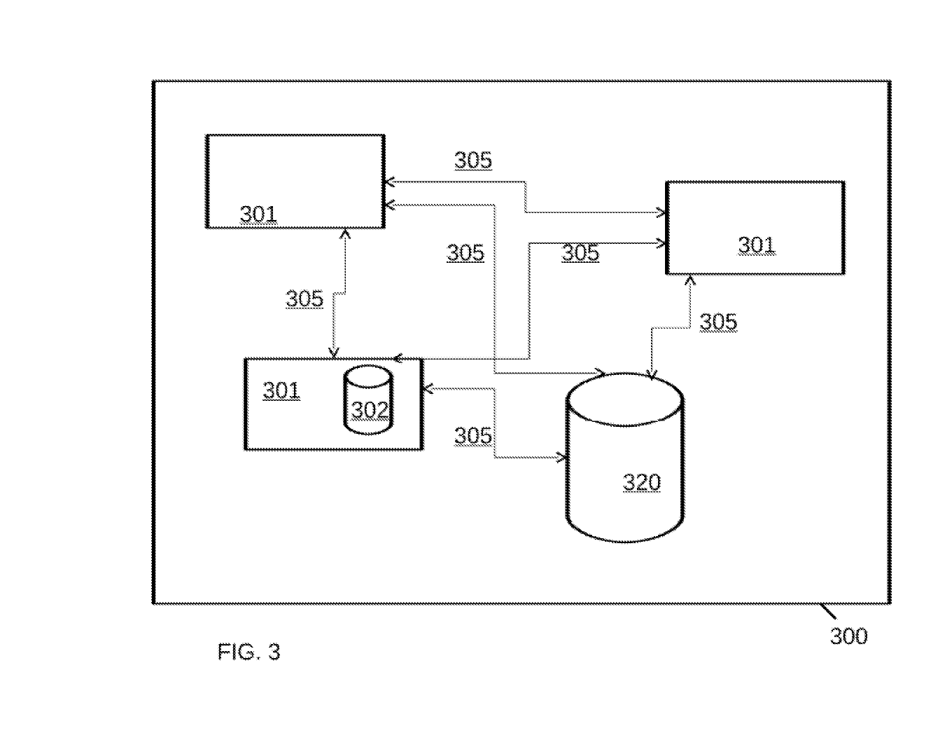

FIG. 3 is a block diagram illustration of one embodiment of the present invention having a facilitated network system 300. As illustrated in FIG. 3, the system comprises a plurality of nodes 301 that are in processing communication with one another. Each node can include one or more processors. Internal and or external memory locations are also included in the system 300. Each node can include its own internal memory as shown at 302 or be in processing communication with other memories, internal to other nodes or provided as an external memory device. An external memory is provided at 320. The system memory can then either be comprised of a single unit that is shared among the many nodes or be comprised of a plurality of components that are in processing communication with one another. The nodes 301 can be locally or remotely located with respect to one another or the system memory. In addition, the processing means through which the nodes are in communication with one another are varied as can be appreciated by those skilled in the art. For example, in one embodiment, one or more nodes can be in processing communication with one another using the world wide web but in other embodiments they can be part of a secured and privatized network. In yet other embodiments, the nodes can be in processing communication using a wireless, satellite or cellular network. FIG. 3 provides an example of this for ease of understanding. The nodes 301 can be comprised of a processor or even a device such as a printer, a workstation, a mobile device such as a smart phone or tablet or the like, or other devices as appreciated by those skilled in the art. Alternatively the nodes can be large processing units having many processors such as servers or enterprise computers. In addition, while FIG. 3 provides an embodiment of a system 300 that is comprised of many nodes in processing communication with one another, the system 300 can be comprised of a single processor or even a workstation or mobile device.

In an embodiment such as that depicted in FIG. 3, different aspects of the embodiment may be implemented by different nodes 301 such that not every aspect is implemented on every node 301, in order to achieve a division of labor as between different nodes 301. Any particular aspect of the embodiment may nonetheless be implemented by a plurality of nodes 301 in order to make those aspects of the embodiment available to a plurality of geographic locations or users or to achieve load balancing or greater reliability through redundancy. It further remains possible for a single node 301 or even for every node 301 to implement every aspect of the embodiment, selectively.

The nodes 301 are in processing communication with one another and the memory via a network 305. The network 305 can be sophisticated or even a simple modem which provides connectivity to one or more component of the system to allow it to communicate with one or more remote systems either on a local network (intranet) or over the Internet. For example, when the Internet is used, it allows for communication between an off-site workstation or mobile device and one or more remote systems.

In one embodiment, at least one server node would store and process state information for at least one user, and at least one client node having a display and a user input device would communicate with a server node. In this example, user input would be communicated from the client node to the server node, the server node would process and store updated state information and the server node would communicate display information to the client node for display on the client node display. State information can include participant identities, records of instances of behavior and their tallies, categories of behavior, outcomes associated with categories of behavior, authentication credentials, user preferences and the like. A server node can be a web server, an intranet server or any other type of server that can be communicatively connected to a client node.

If a plurality of server nodes exist, the server nodes can be communicatively connected to one another in order to share state information, thereby allowing a client node to communicate with any server node without respect to which server node the client node had previously communicated with. In this embodiment, the state information for a plurality of users can be made available collectively such that comparisons between participants can be made, even between participants associated with different users or using different client nodes. The collective state information can be analyzed statistically so that a user can compare the behavior of participants the user is concerned about with the behavior of other participants or with an average or median of the behavior of all or a subset of participants.

In a similar embodiment, a client node can have a memory containing state information in addition to a display and a user input device. The client node memory can then store the state information for the user or users of the client node and allow the client node to operate even while not connected to a server node. The client node can then periodically establish a connection to a server node in order to share state information. This can allow the client node to backup its state information for redundancy or to allow a user to access the state information created using one client node on a different client node. In addition, it can allow the statistical analysis of collectivized state information discussed in connection with the previous embodiment.

It should be noted that the nodes as discussed in FIG. 3 can represent a plurality of electronic devices as can be appreciated by those skilled in the art. For example, the nodes can be represented by a simple system having a singular processor to one that has many networked processors and internal memories. Other devices, such as printers, and graphical devices, such as monitors, laptops etc. can also be provided so that when archives, a participant history or the like are desired, they can also be provided to the appropriate person in form of a printout or graphically or using other such mediums (such as downloads and on CDs).

The ability to view certain levels of participation and/or archived history can also be controlled per user or per participant by a number of ways. For example, as discussed, during an initialization step, the participants or other users (who do not need to be participants if authorized to view), can be asked to authenticate using authentication credentials, such as by means of one or more secure passwords. Password hashes or other such secure means as known to those skilled in the art can be stored/archived in the memory and used on an on-going basis to provide level of access to dynamic and/or previously stored data.

Furthermore, the processing network shown and discussed can also be represented by the internet, or provided by a wireless, satellite or cellular network. In such cases, the behavior modification system as discussed can be further customized to meet the requirements of such a system as appropriate. For example, participants can be the users of one or more smart phones or other mobile devices such as tablets or laptops that are in processing communication with one another. The behavior modification system in such a case will then be provided (via download or other medium) as a particular application that can be customized to run on such a mobile and/or smart phone system as can be appreciated by those skilled in the art. Many other specific applications can also be provided by other such devices as available to the market using different alternative embodiments of the present invention. As examples to aid understanding, such applications may include artificial intelligence, video games, robotics, phones, application of the system to prisons or use with individuals having special needs or disabilities.

While the invention has been described in accordance with certain preferred embodiments thereof, those skilled in the art will understand the many modifications and enhancements which can be made thereto without departing from the true scope and spirit of the invention, which is limited only by the claims appended below.

What is claimed is:

1. An interactive behavior modification system comprising:
a housing having a first area and a second area;
a plurality of tickets disposed in said housing, said tickets contextually arranged by categories of behavior;
said tickets being further contextually arranged by participant; and
a selector of predetermined outcomes, said outcomes being arranged according to said categories of behavior such that an outcome from the set of outcomes associated with a category of behavior may be selected by random chance.

2. The interactive behavior modification system of claim 1, wherein a plurality of depressions is disposed in the first housing area complementary with the configuration and shape of stacks of tickets to enable a secure holding area.

3. The interactive behavior modification system of claim 1, wherein a plurality of perforated slits is disposed in the second housing area complementary with the configuration and shape of tickets to enable a secure holding area.

4. The interactive behavior modification system of claim 1, wherein a plurality of card boxes is disposed on the first housing area for storing archived tickets.

5. The interactive behavior modification system of claim 4, wherein dividers are disposed in the card boxes, capable of dividing tickets by category of behavior.

6. The interactive behavior modification system of claim 1, wherein the selector of predetermined outcomes is a spinner.

7. The interactive behavior modification system of claim 1, further including a means for hanging.

8. In a computing environment having at least a processor and a memory component, a method of providing an interactive behavior modification system comprising:
conducting an initialization step, via said processor, during which at least one participant, a threshold number of instances of behavior to trigger an outcome, and a plurality of categories of behavior are identified, and a plurality of outcomes is associated with each said category of behavior;
evaluating, via said processor, whether the number of instances of behavior by a participant in a category of behavior has exceeded said threshold number of instances of behavior; and
employing, via said processor, a random selector of outcomes to select an outcome to be imparted on the participant from the plurality of outcomes associated with the category of behavior for which said threshold number of instances of behavior has been exceeded.

9. The method of claim 8, further comprising searching for a user profile in said memory during said initialization step and if no such profile exists for a participant, creating said user profile.

10. The method of claim 9, further comprising updating said user profile each time a new behavior event is received for a particular participant.

11. The method of claim 8, wherein the instances of participant behavior are recorded and archived in a memory to create a history of participant behavior.

12. The method of claim 11, wherein said history of participant behavior can be provided graphically using one or more graphical devices in said environment.

13. The method of claim 11, wherein said history and participant behavior can be printed using a printing device housed in said environment.

14. The method of claim 8, wherein a user is authenticated using authentication credentials.

15. The method of claim 14, wherein said user authentication can include providing one or more secure passwords by said user and said user authentication can provide said user different levels of access to data previously stored.

16. The method of claim 15, wherein said user authentication can provide a user different levels of access to data provided by other users.

17. The method of claim 8, wherein a plurality of nodes having one or more processors and memory devices are provided that are in processing communication with one another.

18. The method of claim 17, wherein at least one of said nodes is a mobile device with an application implementation to execute said behavior modification system.

19. The method of claim 17, wherein at least one web browser client node is provided in said environment.

20. A computer program product comprising at least a processor and a memory in communication with one another, including a computer usable medium having computer readable program code means for causing a computer to effect the method steps of:
conducting an initialization step, via a processor, during which at least one participant, a threshold number of instances of behavior to trigger an outcome, and a plurality of categories of behavior are identified, and a plurality of outcomes is associated with each said category of behavior;
evaluating, via the processor, whether the number of instances of behavior by a participant in a category of behavior has exceeded said threshold number of instances of behavior; and
employing, via the processor, a random selector of outcomes to select an outcome to be imparted on the participant from the plurality of outcomes associated with the category of behavior for which said threshold number of instances of behavior has been exceeded.
